(19) United States
(12) Patent Application Publication
(10) Pub. No.: US 2003/0164404 A1
(43) Pub. Date: Sep. 4, 2003

(54) Fuel-injection valve for internal combustion engines

(76) Inventors: Roger Potschin, Brackenheim (DE); Wolfgang Albrecht, Kentwood, MI (US)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/275,886

(22) PCT Filed: Mar. 13, 2002
(86) PCT No.: PCT/DE02/00880

(30) Foreign Application Priority Data
Mar. 15, 2001 (DE) 101 12 426.0

(51) Int. Cl. F02M 47/02

(52) U.S. Cl. 239/88

(57) ABSTRACT

A fuel injection valve with a valve member (10), which cooperates with a valve seat (16) to control injection openings (20). The valve member (10) is guided, in a portion remote from the combustion chamber, in a bore (7) and is surrounded by a pressure chamber (12), which can be filled with fuel at high pressure. The valve member (10) is urged by a spring (27) disposed in a spring chamber (25) and having a closing force in the direction of the valve seat (16), and in an appropriate opening pressure in the pressure chamber (12), as a result of the hydraulic pressure on a pressure shoulder (11), embodied on the valve member (10), the valve member lifts from the valve seat (10) and thus opens the injection openings; the injection of the fuel is effected separately in a main injection and a subsequent postinjection. The pressure chamber (12) and the spring chamber (25) communicate via a throttle connection, so that the pressure in the otherwise closed-off spring chamber (25) rises during the main injection and via the additional hydraulic force on the valve member (10) raises the opening pressure of the postinjection; the pressure in the spring chamber (25) has reached the initial value again by the onset of the next injection cycle (FIG. 1).

### PRIOR ART

The invention is based on a fuel injection valve as generically defined by the preamble to claim 1. One such fuel injection valve is known for instance from German Published, Unexamined Patent Application DE 197 52 496 A1. The fuel injection valve includes a valve body, which is axially braced against a valve holder body. In the valve body, there is a bore in which a pistonlike valve member is disposed longitudinally displaceably. The valve member is guided, in a portion remote from the combustion chamber, in the bore, and on its end toward the combustion chamber it has a valve sealing face, which cooperates with a valve seat, embodied in the valve body, for controlling at least one injection opening. On the end remote from the combustion chamber, the valve member is joined to a spring plate, which protrudes into a spring chamber embodied in the valve holder body, and between which and the end toward the combustion chamber of the spring chamber, a spring is disposed with prestressing. The spring urges the valve member onto the valve seat with a closing force.

The valve member is surrounded by a pressure chamber, which toward the valve seat adjoins the guided portion of the valve member, and which can be filled with fuel at high pressure via an inflow conduit. A pressure face is embodied on the valve member and is acted upon by fuel in the pressure chamber, as a result of which a force on the valve member in the axial direction, counter to the closing force of the spring, is brought about. The opening of the fuel injection valve is effected hydraulically, at a certain fuel pressure in the pressure chamber, and this pressure is called the opening pressure. Between the individual injections, a low static pressure prevails in the pressure chamber; its level is determined by the fuel delivery system.

To reduce pollutant emissions from the engine, it has proved advantageous to introduce the fuel into the combustion chamber not in one step but rather separately, in a main injection and a postinjection; in comparison to the main injection, the postinjection includes only a small fuel quantity. The postinjection should be effected at a pressure that is as high as possible, which because of the small injection quantity is possible only if the opening pressure of the fuel injection valve is raised markedly compared to that of the main injection. In the known fuel injection valve, the spring chamber communicates with the pressure chamber via a throttle gap, which is embodied between the guided portion of the valve member and the bore. The spring chamber is closed off except for this throttle gap, so that fuel that flows through the throttle gap into the spring chamber causes an increase in the fuel pressure there and thus an increased closing force on the valve member. However, the known fuel injection valve has the disadvantage that the fuel pressure in the spring chamber does not drop all the way between injections, and thus a high static pressure is maintained in the spring chamber, which is higher than the pressure in the pressure chamber between successive injections through this injection valve. The result is a delayed, damped opening of the valve member, which makes exact metering and control of an injection, subdivided into a first and a second fractional injection, of the fuel, each with a different opening pressure, in a single cycle of the engine impossible.

### ADVANTAGES OF THE INVENTION

The fuel injection valve of the invention, having the definitive characteristics of claim 1, has the advantage over the prior art that the throttle connection from the pressure chamber into the spring chamber is embodied such that the fuel pressure in the spring chamber increases during the first fractional injection, per working stroke of the applicable engine cylinder, this first fractional injection being called here the main injection, and that the fuel pressure, by the onset of the second fractional injection, has dropped again to an initial pressure which is at least approximately equivalent to the static pressure in the pressure chamber. If the injection is effected in two steps, namely a first and a second fractional injection, here called the main injection and postinjection, then because of the close chronological spacing between the main injection and the postinjection, the pressure in the spring chamber is increased markedly in the postinjection, which leads to an increased opening pressure of the fuel injection valve in the postinjection. As a result, a postinjection at high pressure is achieved, with an attendant reduction in pollutant emissions and less noise emitted by the engine.

The pressure increase in the spring chamber during the main injection can be adapted to the prevailing requirements of the fuel injection valve by means of the volume of the spring chamber and by means of the flow resistance of the throttle connection from the pressure chamber into the spring chamber. In an advantageous feature of the subject of the invention, the pressure rise in the spring chamber during the main injection is increased, because a positive-displacement body that reduces the volume of the spring chamber is disposed in the spring chamber, so that for the same fuel inflow, a greater pressure rise occurs in the spring chamber.

In a further advantageous feature of the subject of the invention, the throttle connection from the pressure chamber to the spring chamber is embodied by an additional bore, in which a suitable throttle cross section is provided. As a result, the throttle connection can be manufactured separately, and the guidance of the valve member in the bore remains unchanged.

Further advantages and advantageous features of the subject of the invention can be learned from the description, drawing and claims.

### DRAWING

In the drawing, one exemplary embodiment of a fuel injection valve of the invention is shown.

FIG. 1 shows a longitudinal section through a fuel injection valve of the invention;

FIG. 2 is an enlarged view of FIG. 1 in the region of the guided portion of the valve member, with some geometrical variables defined;

FIG. 3 is a graph showing the schematic course of the fuel pressure in the spring chamber and in the pressure chamber, and of the valve member stroke, as a function of time;

FIG. 4 is a further illustration of a fuel injection valve of the invention in the region of the spring chamber; and

FIG. 5 is a further illustration of a fuel injection valve of the invention in longitudinal section.

### DESCRIPTION OF THE EXEMPLARY EMBODIMENT

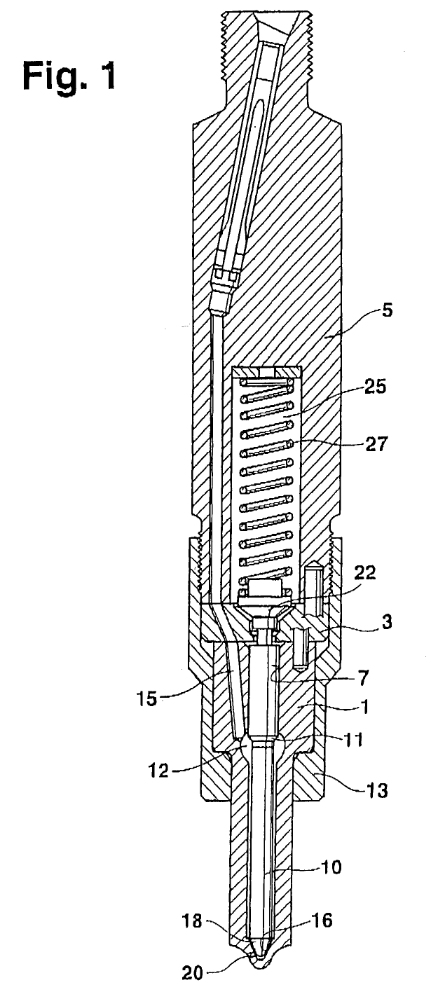

In FIG. 1, a longitudinal section through a fuel injection valve of the invention is shown. A valve body 1 is braced in the axial direction against a valve holding body 5 by means of a lock nut 13, with the interposition of a shim 3. A bore 7 is embodied in the valve body 1, and a valve seat 16 is embodied on the end of the bore toward the combustion chamber; at least one injection opening 20 is disposed in the valve seat and connects the bore 7 with the combustion chamber of the internal combustion engine. A valve member 10 is disposed in the bore 7; it is guided in the bore 7 in a portion remote from the combustion chamber, and it tapers toward the combustion chamber, forming a pressure shoulder 11. On the end of the valve member 10 toward the combustion chamber, there is a valve sealing face 18, which cooperates with the valve seat 16 for controlling the at least one injection opening 20. A pressure chamber 12 is embodied in the valve body 1; it is formed by a radial enlargement of the bore 7, and it surrounds the valve member 10. Toward the valve seat 16, the pressure chamber 12 continues in the form of an annular conduit surrounding the valve member 10, and it can be filled with fuel at high pressure via an inlet conduit 15 extending in the valve body 1, the shim 3 and the valve holding body 5. The inlet conduit 15 communicates, on its end remote from the pressure chamber 12, with a high-pressure fuel system, not shown in the drawing.

The valve member 10, on its end remote from the combustion chamber, is connected to a spring plate 22, disposed in the shim 3, and this spring plate 22 extends into a spring chamber 25 formed in the valve holding body 5. Between the spring plate 22 and the end of the spring chamber 25 remote from the combustion chamber, a spring 27 is disposed with prestressing; it urges the valve member 10 toward the valve seat 16 with a closing force.

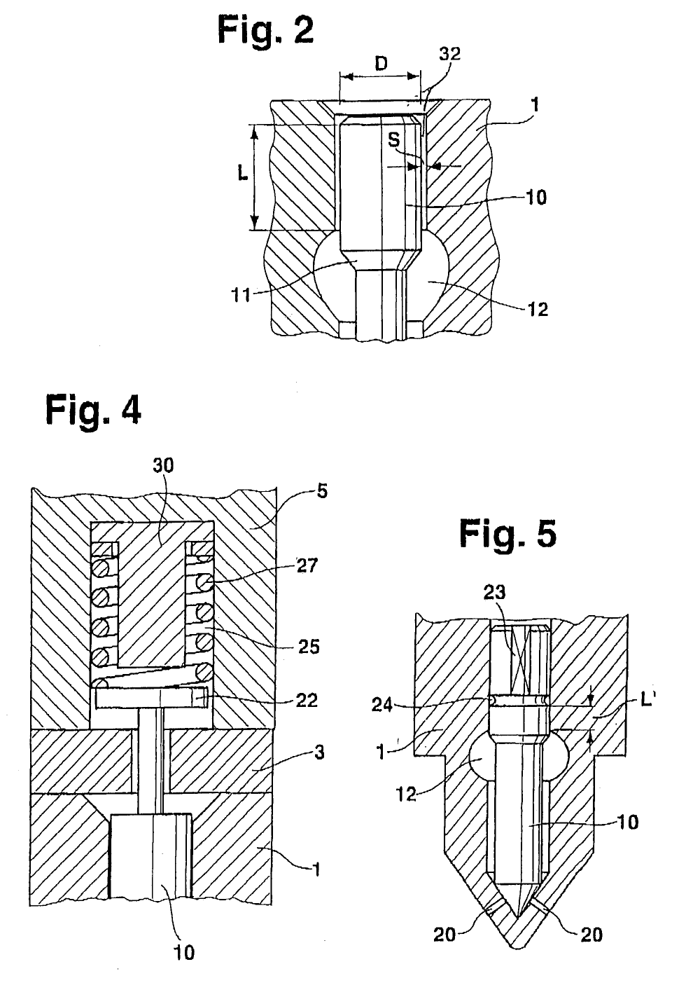

The pressure chamber 12 communicates with the spring chamber 25 via a throttle connection. The throttle connection, in the fuel injection valve shown in FIG. 1 and also on a larger scale in FIG. 2, is embodied by an annular gap 32 formed between the portion of the valve member 10 and the bore 7. The flow resistance of the fuel as it flows through the annular gap 32 is determined here by the length L of the guided portion of the valve member 10, by the throttle gap measurement S of the guided portion of the valve member 10 in the bore 7, and by the diameter D of the bore 7.

The mode of operation of the fuel injection valve is as follows: The injection of the fuel into the combustion chamber of the engine takes place in two steps: First, a main injection quantity is injected into the combustion chamber of the engine, and then, with a certain chronological spacing, a postinjection quantity, which primarily serves to reduce pollutants in the exhaust gas. At the onset of the injection event, a low static pressure p₀ prevails in the inlet conduit 15 and in the pressure chamber 12. By the delivery of fuel into the pressure chamber 12 via the inlet conduit 15, the fuel pressure increases up to a first opening pressure p₁, which is the opening pressure of the main injection, until the hydraulic force acting in the axial direction of the valve member 10 on the pressure shoulder 11 is greater than the force of the closing spring 27 and greater than the hydraulic force, acting on the valve member 10, resulting from the pressure on the faces of the valve member 10 that are exposed to the pressure in the spring chamber 25. The valve member 10 lifts with its valve sealing face 18 from the valve seat 16, and the pressure chamber 12 is made to communicate with the injection openings 20. Since in this opening stroke motion the valve member 10 executes only quite a short stroke, the pressure increase from the positive displacement of the fuel in the spring chamber 25 is slight and has no substantial influence on the function of the fuel injection valve. During the main injection, fuel flows out of the pressure chamber 12 through the throttle connection, embodied as an annular gap 32, into the spring chamber 25, where it increases the fuel pressure. Thus as a result of the fuel pressure delivered via the inlet conduit 15, the fuel pressure in the pressure chamber 12 on the one hand and the pressure in the spring chamber 25 on the other both rise. To terminate the main injection, the fuel delivery through the inlet conduit 15 is stopped. Because the pressure in the spring chamber 25 is by now high, the closure of the valve member 10 already takes place at a fuel pressure in the pressure chamber 12 that is substantially higher than the opening pressure at the onset of the main injection. The valve member 10, acted upon by the force of the spring 27, returns to its closing position and closes the injection openings 20. A short time later, a postinjection is effected by means of a further pumping of a small fuel quantity into the pressure chamber 12. The second opening pressure p₂ of the valve member 10, which is the opening pressure of the postinjection, is now markedly higher than the opening pressure of the main injection, since the fuel pressure in the spring chamber 25 continues to assure an additional force on the face end, remote from the combustion chamber, of the valve member 10 in the direction of the valve seat 16. In other words, the postinjection takes place at a substantially increased pressure, compared to the opening pressure of the main injection, and this has a favorable effect on the pollutant content of the engine, because of the improved atomization of the fuel. Finally, the fuel delivery through the inlet conduit 15 is stopped entirely, and the pressure in the pressure chamber 12 rapidly falls. The valve member 10 is pressed back into the closing position by the pressure in the spring chamber 25 and by the force of the closing spring 27, and the high fuel pressure in the spring chamber 25—in comparison to the pressure chamber 12—leads to a fuel flow out of the spring chamber 25 through the annular gap 32, past the valve member 10, into the pressure chamber 12, until the pressure in the spring chamber 25 has adapted to the static pressure p₀ in the inlet conduit 15. The flow resistance of the throttle connection, which is embodied here as an annular gap 32, is dimensioned such that the fuel pressure in the spring chamber 25, by the onset of the next main injection, has dropped back down to the initial pressure at the onset of the injection event.

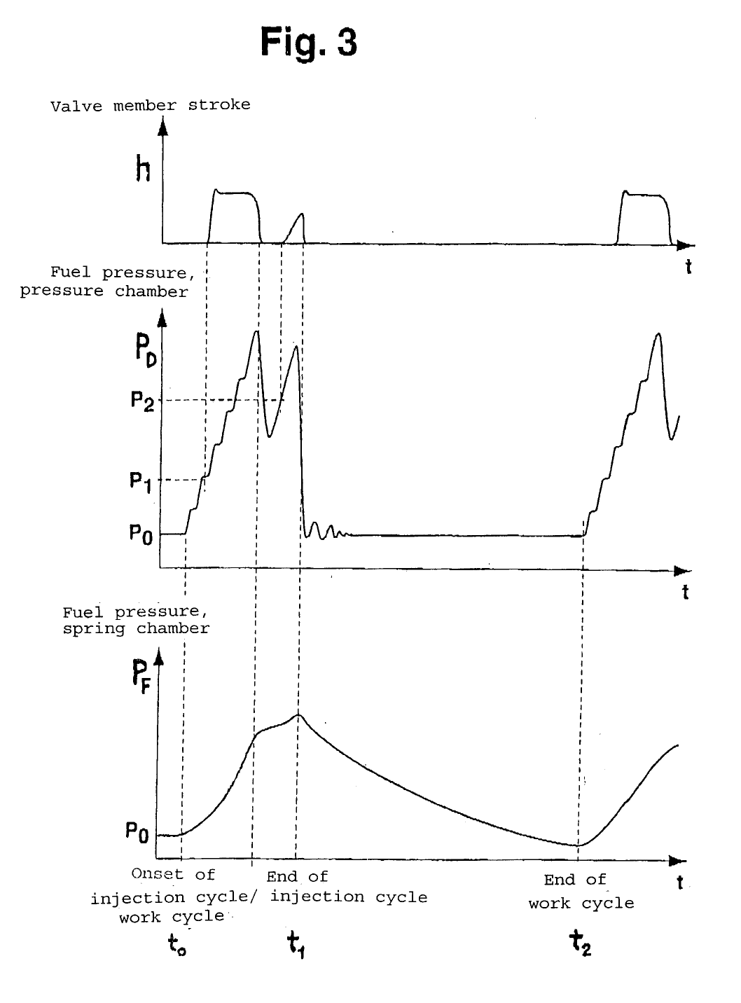

In FIG. 3, the pressure p_{D} in the pressure chamber 12 and the pressure p_{F} in the spring chamber 25 are shown schematically plotted over the valve member stroke h as a function of time t. The top graph shows the course of the valve member stroke; the middle graph shows the course of the fuel pressure p_{D} in the pressure chamber 12; and the bottom graph shows the course of the fuel pressure p_{F} in the spring chamber 25, with the time on the abscissa being the same for all the graphs. The engine is operated in work cycles, and in each work cycle one injection cycle takes place. In the injection cycle, fuel is injected in one or more fractional injections into the combustion chamber of the engine; the duration of the injection cycle as a rule amounts to only a fraction of the duration of the work cycle. At the beginning of the work cycle, at time t₀, which also represents the onset of the injection cycle, the static pressure p₀ prevails in the pressure chamber 12; this pressure rises at the onset of the injection cycle, until the first opening pressure p₁ of the fuel injection valve is reached, and the valve member 10, by its opening stroke motion, opens the injection openings 20. During the entire main injection, the pressure in the pressure chamber 12 continues to increase, and as a result of the inflow of fuel with a slight time lag, it increases in the spring chamber 25 as well. After the termination of the main injection, the valve member 10 closes, and the pressure in the pressure chamber 12 rapidly drops, while the pressure in the spring chamber 25 reacts markedly more slowly and remains relatively high. As a result of the renewed delivery of fuel at the onset of the postinjection, the pressure in the pressure chamber 12 rises again, until the second opening pressure p₂, increased by the fuel pressure in the spring chamber 25, is reached, and the valve member 10 moves into the opening position for the postinjection. After the termination of the postinjection, the pressure in the pressure chamber 12 rapidly drops to the static pressure p₀ again, and the injection cycle is ended at time t₁. The pressure in the spring chamber 25, conversely, requires a longer time to drop back to the static pressure p₀, as a result of an outflow of fuel into the pressure chamber 12 via the throttle connection, but this has occurred by the time of the onset of the next main injection, at time t₂. The duration of the work cycle depends on the engine rpm and is to approximately 0.02 to 0.2 seconds. The duration of the injection cycle depends on the type of engine and amounts for instance to 1/20 of the duration of the work cycle.

In FIG. 4, a further exemplary embodiment of a fuel injection valve of the invention can be seen in the region of the spring chamber 25. To keep the pressure rise in the spring chamber 25 as great as possible during the inflow of a quantity of fuel, the volume must be kept as small as possible. In the present exemplary embodiment, this is achieved by providing that a cylindrical positive-displacement body 30 is disposed in the spring chamber 25 and is surrounded by the closing spring 27, so that the volume of the spring chamber 25 that can be filled with fuel is reduced in size. The length and diameter of the positive-displacement body 30 can vary, so that the volume of the spring chamber 25 can be adapted to various requirements.

In FIG. 5, a further exemplary embodiment of a fuel injection valve of the invention is shown. If the throttle connection from the pressure chamber 12 into the spring chamber 20 is defined solely via the annular gap between the guided portion of the valve member 10 and the bore 7, then under some circumstances, especially if the guided portion L of the valve member 10 is long, the selected throttle gap measurement S must be so great that there is excessive wear on the valve member 10 in the bore 7. If despite this the flow resistance is to be reduced further, this can then be accomplished by providing that a portion of the length L of the guided portion of the valve member 10 be bridged by one or more recesses 23, which extend from the end, remote from the combustion chamber, of the valve member 10 as far as annular groove 24 embodied in the guided portion of the valve member 10. As a result, the effective length L′ of the throttling annular gap 32 is lessened, and thus the flow resistance of the fuel is reduced accordingly.

As an alternative to the embodiment shown in FIG. 5, it can also be provided that recesses on the valve member 10 extend from the end toward the combustion chamber to the end remote from the combustion chamber of the guided portion of the valve member 10. By means of a suitable cross section and a suitable number of these recesses, the flow resistance of the throttle connection can thus be adjusted and adapted to the requirements of the fuel injection valve, without having to change the throttle gap measurement S. It can also be provided that the recesses are disposed on the wall of the guiding portion of the bore 7, the recesses being embodied for instance as longitudinal grooves.

Besides the embodiment of the throttle connection of the pressure chamber 12 to the spring chamber 25 by means of an annular gap 32 between the valve member 10 and the bore 7, it can also be provided that the throttle connection be created by a separate fuel conduit with a throttle cross section, this fuel conduit extending in the valve body 1 and connecting the pressure chamber 12 to the spring chamber 25.

1. A fuel injection valve for internal combustion engines, having a valve body (1) in which a valve member (10) is disposed longitudinally displaceably in a bore (7), which valve member, on its end toward the combustion chamber, has a valve sealing face (18) that cooperates with a valve seat (16), embodied in the valve body (1), for controlling at least one injection opening (20), and remote from the combustion chamber, the valve member (10) protrudes at least indirectly into a spring chamber (25), where it is urged toward the valve seat (16) by a spring (27) disposed in the spring chamber (25), and having a pressure chamber (12) which can be filled with fuel and surrounds the valve member (10) and in which a pressure face (11) embodied on the valve member (10) is disposed, so that by delivering fuel to the pressure chamber (12), the fuel pressure there increases, beginning at a static pressure (p₀), and exerts a hydraulic force, oriented counter to the closing force of the spring (27), on the pressure face (11), as a result of which the valve member (10), at an opening pressure (p₁; p₂) in the pressure chamber (12), is moved from a closing position to an opening position, in which opening position a fuel injection takes place through the at least one injection opening (20), and having a throttle connection, embodied between the pressure chamber (12) and the spring chamber (25), the spring chamber (25) being closed off except for this throttle connection, characterized in that the throttle connection is embodied such that the pressure in the spring chamber (25), after the termination of the injection cycle until the onset of the next injection cycle, has dropped at least approximately to the static pressure.

2. The fuel injection valve of claim 1, characterized in that the injection in an injection cycle is effected by means of fractional injections with at least a first fractional injection and a second, successive fractional injection.

3. The fuel injection valve of claim 2, characterized in that the opening pressure (p₂) of the second fractional injection is higher than the opening pressure (p₁) of the first fractional injection.

4. The fuel injection valve of claim 1, characterized in that the throttle connection is formed by an annular gap (32) embodied between a guided portion of the valve member (10) and the bore (7).

5. The fuel injection valve of claim 1, characterized in that the throttle connection is formed by recesses (23) on the valve member (10).

6. The fuel injection valve of claim 5, characterized in that the recesses (23) extend over part of the length of the guided portion of the valve member (10).

7. The fuel injection valve of claim 1, characterized in that the throttle connection is formed by recesses on the guiding portion of the bore (7).

8. The fuel injection valve of claim 7, characterized in that the recesses extend over part of the length of the guided portion of the valve member (10).

9. The fuel injection valve of claim 1, characterized in that disposed on the spring chamber (25) is a positive-displacement body secured to the wall of the spring chamber.

10. The fuel injection valve of claim 9, characterized in that the positive-displacement body (30) is embodied in pistonlike form and is surrounded by the spring element (25).

11. The fuel injection valve of claim 1, characterized in that the fuel in the spring chamber acts upon at least part of the end face, remote from the combustion chamber, of the valve member (10).

12. The fuel injection valve of claim 1, characterized in that the throttle connection is formed by a connecting conduit, in which a throttle cross section is disposed and which connects the pressure chamber (12) with the spring chamber (25).
